(19) United States
(12) Patent Application Publication
(10) Pub. No.: US 2026/0267365 A1
(43) Pub. Date: Sep. 10, 2026

(54) CONSTANT CURRENT SOURCE CIRCUIT

(71) Applicant: Renesas Electronics Corporation, Tokyo (JP)

(72) Inventor: Takeshi UCHIIKE, Tokyo (JP)

(21) Appl. No.: 19/542,792

(22) Filed: Feb. 18, 2026

(30) Foreign Application Priority Data
Mar. 5, 2025 (JP) 2025-034360

(51) Int. Cl. G05F 3/24

(52) U.S. Cl. CPC G05F 3/245

(57) ABSTRACT

To provide a constant current source circuit with reduced temperature dependence without using bipolar transistors. To provide a constant current source circuit comprising: an operational amplifier; a first P-channel MOS transistor having a gate coupled to a output terminal of the operational amplifier; a second P-channel MOS transistor having a gate coupled to the output terminal of the operational amplifier; a first resistor element having a second terminal coupled to an inverting input terminal of the operational amplifier; a second resistor element having a second terminal coupled to a non-inverting input terminal of the operational amplifier; a third resistor element; a first N-channel MOS transistor having a drain coupled to the inverting input terminal of the operational amplifier; and a second N-channel MOS transistor having a gate coupled to the inverting input terminal of the operational amplifier and a drain coupled to the non-inverting input terminal of the operational amplifier.

### CROSS-REFERENCE TO RELATED APPLICATIONS

The disclosure of Japanese Patent Application No. 2025-034360 filed on Mar. 5, 2025, including the specification, drawings and abstract is incorporated herein by reference in its entirety.

### BACKGROUND

This disclosure relates to a constant current source circuit.

There are disclosed techniques listed below.
[Patent Document 1] Japanese Unexamined Patent Application Publication No. 2004-15423

A constant current source circuit with low temperature dependency has been developed. The fundamental concept of a constant current source circuit with low temperature dependency is to generate it by adding a current Iptat that increases proportionally with temperature and a current Ictat that decreases proportionally with temperature.

To generate Iptat and Ictat, it is common to use a bipolar transistor to convert the Vbe difference and Vbe of the bipolar transistor into current using resistors respectively. Therefore, diffusion technology capable of forming bipolar transistors is required to generate a constant current with low temperature dependency.

On the other hand, in products such as IPD (Intelligent Power Device), the diffusion process may be reduced due to cost reduction, making it impossible to form bipolar transistors.

### SUMMARY

Therefore, the purpose of this disclosure is to provide a constant current source circuit with low temperature dependency without using bipolar transistors.

Other objects and novel features will become apparent from the description of this specification and the accompanying drawings.

According to one embodiment, the constant current source circuit is composed of MOS transistors.

According to the embodiment, a constant current source circuit with low temperature dependency can be provided without using bipolar transistors.

### BRIEF DESCRIPTION OF THE DRAWINGS

FIG. 1 is a circuit diagram of a constant current source circuit according to related technology.

FIG. 2 is a diagram showing an example of an IPD (Intelligent configuration using the constant current source Power Device) circuit according to the embodiment.

FIG. 3 is a circuit diagram showing an example configuration of the constant current source circuit according to the embodiment.

FIG. 4 is a diagram simulating the temperature dependency in the constant current source circuit according to the embodiment.

FIG. 5 is a circuit diagram showing an example configuration of a constant current source circuit according to another embodiment.

### DETAILED DESCRIPTION

### Embodiment

For clarity of explanation, the following description and drawings are appropriately omitted and simplified. Additionally, each element described in the drawings as functional blocks performing various processes can be configured by hardware such as a CPU (Central Processing Unit), memory, and other circuits, and can be implemented by software such as programs loaded into memory. Therefore, these functional blocks can be realized by hardware, software operating on hardware, or a combination thereof. In the drawings, the same elements are denoted by the same reference numerals, and a repetitive description thereof is omitted as necessary.

### (Description of the Constant Current Source Circuit According to Related Technology)

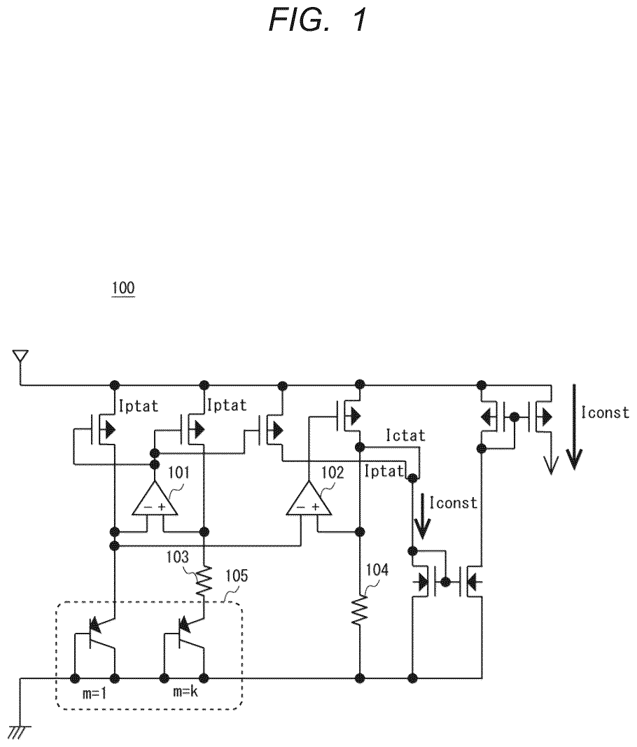

FIG. 1 is a circuit diagram of a constant current source circuit according to related technology. Referring to FIG. 1, the constant current source circuit according to related technology will be described.

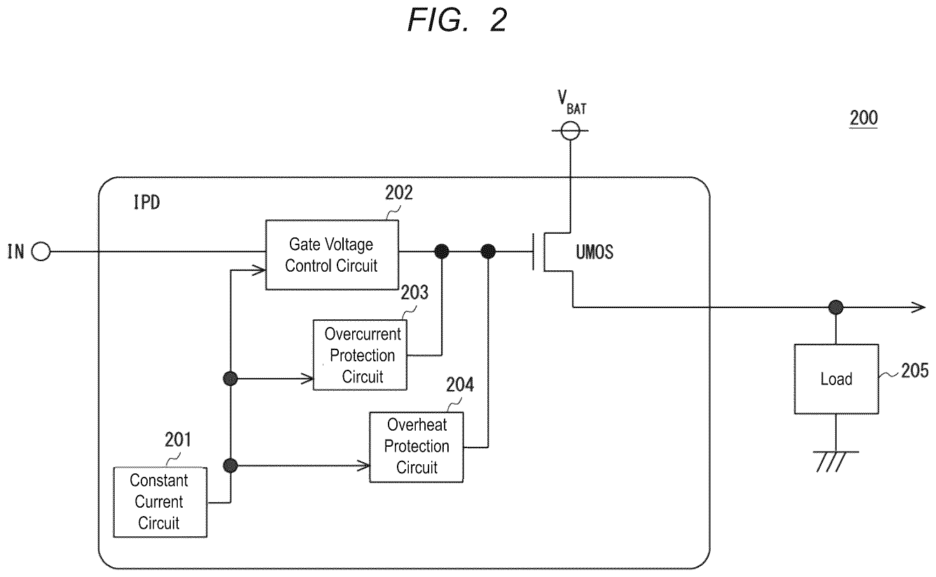

As shown in FIG. 1, a constant current source circuit 100 according to related technology includes operational amplifiers 101 and 102, resistor elements 103 and 104, and a bipolar transistor 105. The constant current source circuit 100 requires a startup circuit, but it is omitted from FIG. 2.

In the bipolar transistor 105, m=k indicates that k is a natural number, and k bipolar transistors are coupled in parallel. The resistor element 103 converts the potential difference Vbe into current and generates Iptat. The resistor element 104 generates Ictat. The sum of Iptat and Ictat was the output Iconst. Iconst is a current with low temperature dependency. Thus, a bipolar transistor was necessary.

However, due to the reduction of the diffusion process, it is necessary to replace the bipolar transistor with a MOS transistor.

### (Description of the IPD (Intelligent Power Device) Using the Constant Current Source Circuit According to the Embodiment)

FIG. 2 is a diagram showing an example of an IPD (Intelligent Power Device) configuration using the constant current source circuit according to the embodiment. Referring to FIG. 2, the IPD using the constant current source circuit according to the embodiment will be described. IPD refers to a high-performance semiconductor power switch that incorporates a protection circuit and can absorb energy from inductive loads and the like.

As shown in FIG. 2, the IPD includes a constant current source circuit 201, a gate voltage control circuit 202, an overcurrent protection circuit 203, an overheat protection circuit 204, and a UMOS (trench-gate type MOSFET). UMOS is widely used as a switching element with a relatively low breakdown voltage of 30-100V, such as in the power supply of a PC (Personal Computer). A load 205 is coupled to the UMOS.

The constant current source circuit 201 supplies bias current to the gate voltage control circuit 202, the overcurrent protection circuit 203, and the overheat protection circuit 204 inside the IPD. If the bias current is independent of temperature, a suppressive effect on the temperature dependency of each circuit can also be expected.

### (Description of the Constant Current Source Circuit According to the Embodiment)

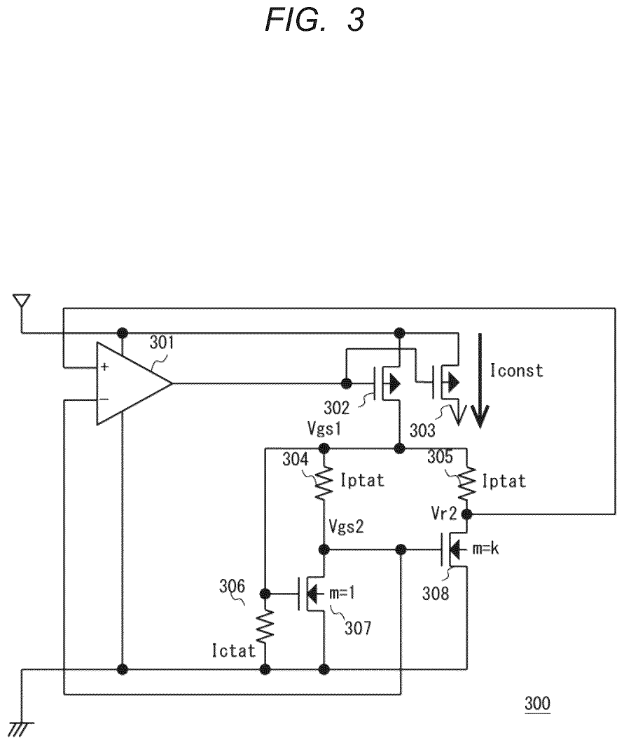

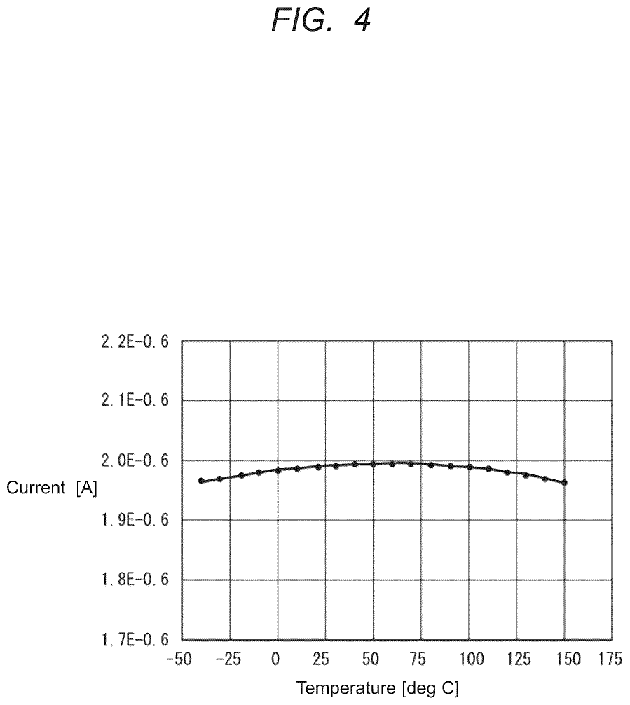

FIG. 3 is a circuit diagram showing an example configuration of the constant current source circuit according to the embodiment. FIG. 4 is a diagram simulating the temperature dependency in the constant current source circuit according to the embodiment. Referring to FIGS. 3 and 4, the constant current source circuit according to the embodiment will be described.

As shown in FIG. 3, the constant current source circuit 300 according to the embodiment includes an operational amplifier 301, a first P-channel MOS transistor 302, a second P-channel MOS transistor 303, a first resistor element 304, a second resistor element 305, a third resistor element 306, a first N-channel MOS transistor 307, and a second N-channel MOS transistor 308.

The operational amplifier 301 is coupled to a high reference potential and a low reference potential. The high reference potential is, for example, the power supply potential. The low reference potential is a potential lower than the high reference potential, for example, the ground potential. The first P-channel MOS transistor 302 has its source coupled to the high reference potential and its gate coupled to the output terminal of the operational amplifier 301.

The second P-channel MOS transistor 303 has its source coupled to the high reference potential, its gate coupled to the output terminal of the operational amplifier 301, and its drain coupled to the output of the constant current source circuit. That is, the current Iconst flowing through the second P-channel MOS transistor is a constant current with low temperature dependency.

The first resistor element 304 has its first terminal coupled to a drain of the first P-channel MOS transistor 302 and its second terminal coupled to the inverting input terminal of the operational amplifier 301. The second resistor element 305 has its first terminal coupled to the drain of the first P-channel MOS transistor 302 and its second terminal coupled to the non-inverting input terminal of the operational amplifier 301. The first resistor element 304 and the second resistor element 305 generate Iptat. The resistance values of the first resistor element 304 and the second resistor element 305 are equal.

The third resistor element 306 has its first terminal coupled to the drain of the first P-channel MOS transistor 302 and its second terminal coupled to the low reference potential. The third resistor element 306 generates Ictat. It is preferable that the first resistor element 304, the second resistor element 305, and the third resistor element 306 are unit resistors. A unit resistor is a resistor that is finely divided and coupled in parallel or in series. Unit resistors are advantageous in the manufacturing process because the same resistors can be used.

The first N-channel MOS transistor 307 has its source coupled to the low reference potential, its gate coupled to the drain of the first P-channel MOS transistor 302, and its drain coupled to the inverting input terminal of the operational amplifier 301. That is, the drain of the first N-channel MOS transistor 307 is coupled to the second terminal of the first resistor element 304. Also, the gate of the first N-channel MOS transistor 307 is coupled to the first terminal of the first resistor element 304. Also, the gate of the first N-channel MOS transistor 307 is coupled to the first terminal of the third resistor element 306.

The second N-channel MOS transistor 308 has its source coupled to the low reference potential, its gate coupled to the inverting input terminal of the operational amplifier 301, and its drain coupled to the non-inverting input terminal of the operational amplifier 301. The gate of the second N-channel MOS transistor 308 is coupled to the second terminal of the first resistor element 304 and the drain of the first N-channel MOS transistor 307. Also, the drain of the second N-channel MOS transistor 308 is coupled to the second terminal of the second resistor element 305.

The indication m=k for the second N-channel MOS transistor 308 means that k is a natural number and k transistors are coupled in parallel. k may represent two or more. Therefore, if the performance of the first N-channel MOS transistor 307 and the second N-channel MOS transistor 308 is the same, the number of the second N-channel MOS transistor 308 is an integer multiple of the number of the first N-channel MOS transistor 307.

Also, the second resistor element 305 is coupled in parallel in the same k number. Also, the second N-channel MOS transistor 308 and the second resistor element 305 are coupled in series to correspond.

The gate Vgs1 of the first N-channel MOS transistor 307 and the gate Vgs2 of the second N-channel MOS transistor 308 are coupled to the first resistor element 304, and the voltage difference Vgs is converted into current by the first resistor element 304. This current is Iptat.

The second resistor element 305 has its first terminal coupled to Vgs1, and due to the imaginary short of the operational amplifier 301, Vgs2 is set to Vr2. When the resistance values of the first resistor element 304 and the second resistor element 305 are equal, the same current flows through both.

The third resistor element 306 is coupled to the low reference potential and Vgs1. The third resistor element 306 converts the Vgs1 voltage into current. That current is Ictat.

The first P-channel MOS transistor 302 supplies a current of Ictat and 2(Iptat). By connecting the first P-channel MOS Ictat transistor 302 and the second P-channel MOS transistor 303 in a current mirror configuration, a constant current of Ictat+2 (Iptat) can be extracted from the drain of the second P-channel MOS transistor 303.

When the MOS transistor is operated in weak inversion, the drain current Id can be approximated by the following exponential function.

$$\begin{matrix}[ Equation 1 ] & \\ Id = {KI}_{0} exp ( \frac{Vgs - Vth}{η {V}_{T}} ) & ( 1 )\end{matrix}$$

Here, K is the W/L ratio of the MOS transistor, 10 is a drain current when Vgs−Vth=0, Vgs is the gate-source voltage of the MOS transistor, Vth is the threshold voltage of the MOS transistor, n is a constant derived from the device structure, and VT is KT/q. When transformed,

$$\begin{matrix}[ Equation 2 ] & \\ \to Vgs - Vth = η {V}_{T} ln ( \frac{Id}{{KI}_{0}} ) & ( 2 )\end{matrix}$$

$$\begin{matrix}[ Equation 2 ] & \\ Vgs = Vth + η {V}_{T} ln ( \frac{Id}{{KI}_{0}} ) & ( 3 )\end{matrix}$$

Expressing Iconst in an equation,

$$\begin{matrix}[ Equation 4 ] & \\ Iconst = Ictat + 2 ( Iptat ) & ( 4 )\end{matrix}$$

$$\begin{matrix}[ Equation 5 ] & \\ Iconst = \frac{Vgs 1}{R 3} + 2 ( \frac{Vgs 1 - Vgs 2}{R 1} ) & ( 5 )\end{matrix}$$

Substituting equation (4),

$$\begin{matrix}[ Equation 6 ] & \\ = \frac{Vth}{R 3} + η {V}_{T} ln ( \frac{Iptat}{{I}_{0}} ) + \frac{2}{R 1} η {V}_{T} ln ( n ) & ( 6 )\end{matrix}$$

$$\begin{matrix}[ Equation 7 ] & \\ = \frac{Vth}{R 3} + η {V}_{T} ln ( \frac{\frac{1}{R 1} η {V}_{T} ln ( n ) )}{{I}_{0}} ) + \frac{2}{R 1} η {V}_{T} ln ( n ) & ( 7 )\end{matrix}$$

### Here,

$$\begin{matrix}[ Equation 8 ] & \\ \frac{Vth}{R 3} & \end{matrix}$$

The term has a negative temperature coefficient,

$$\begin{matrix}[ Equation 9 ] & \\ η {V}_{T} ln ( \frac{\frac{1}{R 1} η {V}_{T} ln ( n )}{{I}_{0}} ) + \frac{2}{R 1} η {V}_{T} ln ( n ) & \end{matrix}$$

The term,

$$\begin{matrix}[ Equation 10 ] & \\ {V}_{T} , \frac{k}{q} T & \end{matrix}$$

is proportional to a positive temperature coefficient, so by adjusting R3, R1, and n, the temperature dependence of the current Iconst can be minimized or controlled to any desired temperature characteristic. Here, n is the same as the natural number k.

FIG. 4 shows the results of creating an actual circuit, adjusting R3, R1, and n, and simulating. As shown in FIG. 4, the change in current with respect to temperature is small.

### (Description of a Constant Current Source Circuit According to Another Embodiment)

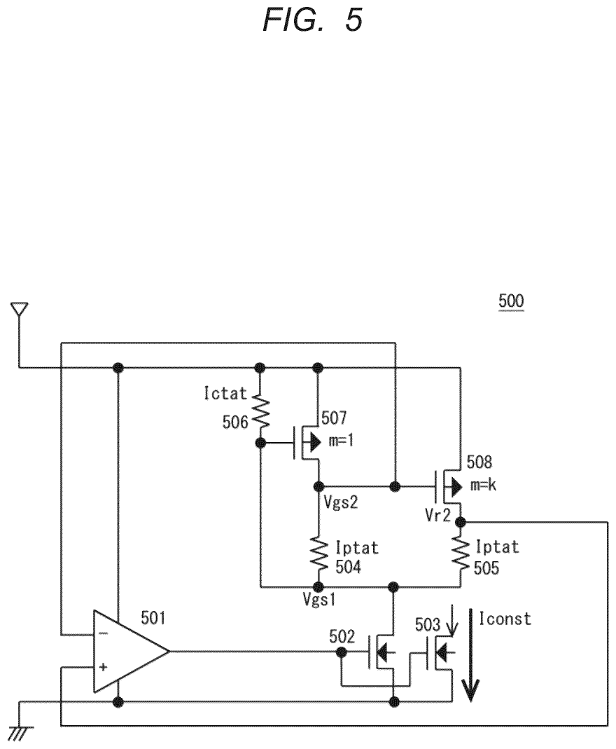

FIG. 5 is a circuit diagram showing a configuration example of a constant current source circuit according to another embodiment. Referring to FIG. 5, the constant current source circuit according to another embodiment will be described.

As shown in FIG. 5, a constant current source circuit 500 according to another embodiment includes an operational amplifier 501, a first N-channel MOS transistor 502, a second N-channel MOS transistor 503, a first resistor element 504, a second resistor element 505, a third resistor element 506, a first P-channel MOS transistor 507, and a second P-channel MOS transistor 508.

The operational amplifier 501 is coupled to a high reference potential and a low reference potential. The first N-channel MOS transistor 502 has its source coupled to the high reference potential and its gate coupled to the output terminal of the operational amplifier.

The second N-channel MOS transistor 503 has its source coupled to the high reference potential, its gate coupled to the output terminal of the operational amplifier, and its drain coupled to the output of the constant current source circuit. That is, the current flowing through the second N-channel MOS transistor is a constant current Iconst with little temperature dependence.

The first resistor element 504 has its first terminal coupled to a drain of the first N-channel MOS transistor 502 and its second terminal coupled to the inverting input terminal of the operational amplifier 501. The second resistor element 505 has its first terminal coupled to the drain of the first N-channel MOS transistor 502 and its second terminal coupled to the non-inverting input terminal of the operational amplifier 501. The first resistor element 504 and the second resistor element 505 generate Iptat. The resistance values of the first resistor element 504 and the second resistor element 505 are equal.

The third resistor element 506 has its first terminal coupled to the drain of the first N-channel MOS transistor 502 and its second terminal coupled to the low reference potential. The third resistor element 506 generates Ictat. It is preferable that the first resistor element 504, the second resistor element 505, and the third resistor element 506 are unit resistors. A unit resistor is a resistor that is finely divided and coupled in parallel or series. Unit resistors are advantageous in the manufacturing process because the same resistors can be used.

The first P-channel MOS transistor 507 has its source coupled to the high reference potential, its gate coupled to the drain of the first N-channel MOS transistor 502, and its drain coupled to the inverting input terminal of the operational amplifier 501. That is, the drain of the first P-channel MOS transistor 507 is coupled to the second terminal of the first resistor element 504. Also, the gate of the first P-channel MOS transistor 507 is coupled to the first terminal of the first resistor element 504. Also, the gate of the first P-channel MOS transistor 507 is coupled to the first terminal of the third resistor element 506.

The second P-channel MOS transistor 508 has its source coupled to the high reference potential, its gate coupled to the inverting input terminal of the operational amplifier 501, and its drain coupled to the non-inverting input terminal of the operational amplifier 501. The gate of the second P-channel MOS transistor 508 is coupled to the second terminal of the first resistor element 504 and the drain of the first P-channel MOS transistor 507. Also, the drain of the second P-channel MOS transistor 508 is coupled to the second terminal of the second resistor element 505.

The indication that the second P-channel MOS transistor 508 is m=k means that k is a natural number and that k are coupled in parallel. k may represent two or more. Therefore, if the performance of the first P-channel MOS transistor 507 and the second P-channel MOS transistor 508 is the same, the number of the second P-channel MOS transistor 508 is an integer multiple of the number of the first P-channel MOS transistor 507.

Also, the second resistor element 505 is coupled in parallel in the same k number. Also, the second P-channel MOS transistor 508 and the second resistor element 505 are coupled in series to correspond.

The constant current source circuit 500 according to the above another embodiment is a constant current source circuit based on the low reference potential. The constant current source circuit 500 according to another embodiment can reduce or control temperature dependence.

It should be noted that the present invention is not limited to the above embodiments and can be appropriately modified without departing from the spirit of the invention.

What is claimed is:

1. A constant current source circuit comprising:
an operational amplifier coupled to a high reference potential and a low reference potential;
a first P-channel MOS transistor having a source coupled to the high reference potential and a gate coupled to an output terminal of the operational amplifier;
a second P-channel MOS transistor having a source coupled to the high reference potential and a gate coupled to the output terminal of the operational amplifier;
a first resistor element having a first terminal coupled to a drain of the first P-channel MOS transistor and a second terminal coupled to an input inverting terminal of the operational amplifier;
a second resistor element having a first terminal coupled to the drain of the first P-channel MOS transistor and a second terminal coupled to a non-inverting input terminal of the operational amplifier;
a third resistor element having a first terminal coupled to the drain of the first P-channel MOS transistor and a second terminal coupled to the low reference potential;
a first N-channel MOS transistor having a source coupled to the low reference potential, a gate coupled to the drain of the first P-channel MOS transistor, and a drain coupled to the inverting input terminal of the operational amplifier; and
a second N-channel MOS transistor having a source coupled to the low reference potential, a gate coupled to the inverting input terminal of the operational amplifier, and a drain coupled to the non-inverting input terminal of the operational amplifier.

2. The constant current source circuit according to claim 1, wherein a plurality of the second N-channel MOS transistors is coupled in parallel, and a plurality of the second resistor elements correspond to the second N-channel MOS transistors.

3. The constant current source circuit according to claim 1, wherein temperature characteristics of the first resistor element, the second resistor element, and the third resistor element are equal.

4. The constant current source circuit according to claim 1, wherein the resistance values of the first resistor element and the second resistor element are equal.

5. The constant current source circuit according to claim 1, wherein the first resistor element and the third resistor element are unit resistors.

6. The constant current source circuit according to claim 1, wherein a number of the second N-channel MOS transistors is an integer multiple of a number of the first N-channel MOS transistors.

7. The constant current source circuit according to claim 2, wherein the resistance value of the first resistor element, the resistance value of the third resistor element, and a number of the second resistor elements and a number of the second N-channel MOS transistors are adjusted to control temperature dependence.

8. A constant current source circuit comprising:
an operational amplifier coupled to a high reference potential and a low reference potential;
a first N-channel MOS transistor having a source coupled to the low reference potential and a gate coupled to an output terminal of the operational amplifier;
a second N-channel MOS transistor having a source coupled to the low reference potential and a gate coupled to the output terminal of the operational amplifier;
a first resistor element having a first terminal coupled to a drain of the first N-channel MOS transistor and a second terminal coupled to an inverting input terminal of the operational amplifier;
a second resistor element having a first terminal coupled to the drain of the first N-channel MOS transistor and a second terminal coupled to a non-inverting input terminal of the operational amplifier;
a third resistor element having a first terminal coupled to the drain of the first N-channel MOS transistor and a second terminal coupled to the high reference potential;
a first P-channel MOS transistor having a source coupled to the high reference potential, a gate coupled to the drain of the first N-channel MOS transistor, and a drain coupled to the inverting input terminal of the operational amplifier; and
a second P-channel MOS transistor having a source coupled to the high reference potential, a gate coupled to the inverting input terminal of the operational amplifier, and a drain coupled to the non-inverting input terminal of the operational amplifier.

9. The constant current source circuit according to claim 8, wherein a plurality of the second P-channel MOS transistors are coupled in parallel, and a plurality of second resistor elements correspond to the second P-channel MOS transistors.

10. The constant current source circuit according to claim 8, wherein temperature characteristics of the first resistor element, the second resistor element, and the third resistor element are equal.

11. The constant current source circuit according to claim 8, wherein the resistance values of the first resistor element and the second resistor element are equal.

12. The constant current source circuit according to claim 8, wherein the first resistor element and the third resistor element are unit resistors.

13. The constant current source circuit according to claim 8, wherein a number of the second P-channel MOS transistors is an integer multiple of a number of first P-channel MOS transistors.

14. The constant current source circuit according to claim 9, wherein the resistance value of the first resistor element, the resistance value of the third resistor element, and a number of the second resistor elements and a number of the second P-channel MOS transistors are adjusted to control temperature dependence.
